(19) United States
(12) Patent Application Publication
(10) Pub. No.: US 2021/0279587 A1
(43) Pub. Date: Sep. 9, 2021

(54) METHOD AND APPARATUS FOR NEURAL NETWORK CODE GENERATION

(71) Applicants: Samsung Electronics Co., Ltd., Suwon-si (KR); SNU R&DB FOUNDATION, Seoul (KR)

(72) Inventors: Bernhard EGGER, Seoul (KR); Minsu KIM, Seoul (KR); Hyemi MIN, Seoul (KR)

(73) Assignees: Samsung Electronics Co., Ltd., Suwon-si (KR); SNU R&DB FOUNDATION, Seoul (KR)

(21) Appl. No.: 17/190,832

(22) Filed: Mar. 3, 2021

Related U.S. Application Data
(60) Provisional application No. 62/985,470, filed on Mar. 5, 2020.

(30) Foreign Application Priority Data
Oct. 22, 2020 (KR) 10-2020-0137442

(51) Int. Cl. G06N 3/08; G06N 3/063; G06F 9/50

(52) U.S. Cl. CPC G06N 3/082; G06F 9/5061; G06N 3/063

(57) ABSTRACT

A method and an apparatus for generating a code for a neural network operation are disclosed. The method includes receiving information on hardware configured to perform a neural network operation of the neural network, generating, using a processor, a target mapping model mapping the neural network operation on processing elements available to perform the neural network operation based on the information and a structure of the neural network, and generating a code to configure the hardware to perform the neural network operation based on the target mapping model.

### CROSS-REFERENCE TO RELATED APPLICATIONS

This application claims the benefit under 35 U.S.C. § 119(e) of U.S. Provisional Application No. 62/985,470 filed on Mar. 5, 2020, in the U.S. Patent and Trademark Office, and claims the benefit under 35 U.S.C. § 119(a) of Korean Patent Application No. 10-2020-0137442, filed on Oct. 22, 2020, in the Korean Intellectual Property Office, the entire disclosures of which are incorporated herein by reference for all purposes.

### BACKGROUND

### Field

The following description relates to a method and apparatus for generating a code for a neural network operation.

### Description of Related Art

In deep neural network operations, input, weight, and output data are needed. Each data may have four dimensions, i.e., a width (or horizontal length), a height (or vertical length), a channel (or depth), and the number.

The number of reload and a performance of a device may vary based on a tiling method for determining which dimensional data is to be divided and loaded into what size and a dataflow that determines the order to load tiled data.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, there is provided a processor-implemented method of generating a code, the method including receiving information on hardware configured to perform a neural network operation of the neural network, generating, using a processor, a target mapping model mapping the neural network operation on processing elements available to perform the neural network operation based on the information and a structure of the neural network, and generating a code to configure the hardware to perform the neural network operation based on the target mapping model.

The receiving of the information may include receiving any one or any combination of a number of the processing elements, a structure of the processing element, a memory bandwidth, a frequency, and a memory size.

The generating of the target mapping model may include calculating a mapping parameter corresponding to an arbitrary mapping model based on the information and the structure, and determining the target mapping model based on the mapping parameter.

The calculating of the mapping parameter may include calculating an operation performance to be attained by the arbitrary mapping model based on a partition structure of the neural network, calculating a memory access size for the arbitrary mapping model based on a loop structure included in the neural network operation, and calculating the mapping parameter based on the operation performance and the memory access size.

The calculating of the operation performance may include calculating a utilization rate of the processing elements based on the partition structure of the neural network, and calculating the operation performance based on the utilization rate.

The calculating of the memory access size may include calculating a number of data reload of the arbitrary mapping model based on the loop structure, and calculating the memory access size based on the number of data reload and the partition structure.

The determining of the target mapping model based on the mapping parameter may include determining an arbitrary mapping model that maximizes the mapping parameter to be the target mapping model.

The generating of the target mapping model further may include pruning an inadequate mapping model based on a partition structure of the neural network and a loop structure included in the neural network operation.

The pruning of the inadequate mapping model may include pruning the inadequate mapping model based on a partition structure of a neural network according to a utilization rate of the processing elements.

The pruning of the inadequate mapping model may include pruning the inadequate mapping model based on a number of iterations of the loop structure.

In another general aspect, there is provided an apparatus for generating a code for a neural network operation, the apparatus including a receiver configured to receive information on hardware configured to perform the neural network operation, and a processor configured to generate a target mapping model mapping the neural network operation on processing elements available to perform the neural network operation based on the information and a structure of the neural network and to generate a code to configure the hardware to perform the neural network operation based on the target mapping model.

The receiver may be configured to receive any one or any combination of a number of the processing elements, a structure of the processing element, a memory bandwidth, a frequency, and a memory size.

The processor may be configured to calculate a mapping parameter corresponding to an arbitrary mapping model based on the information and the structure, and determine the target mapping model based on the mapping parameter.

The processor may be configured to calculate an operation performance to be attained by the arbitrary mapping model based on a partition structure of the neural network, calculate a memory access size for the arbitrary mapping model based on a loop structure included in the neural network operation, and calculate the mapping parameter based on the operation performance and the memory access size.

The processor may be configured to calculate a utilization rate of the processing elements based on the partition structure of the neural network, and calculate the operation performance based on the utilization rate.

The processor may be configured to calculate a number of data reload of the arbitrary mapping model based on the loop structure, and calculate the memory access size based on the number of data reload and the partition structure.

The processor may be configured to determine an arbitrary mapping model that maximizes the mapping parameter to be the target mapping model.

The processor may be configured to prune an inadequate mapping model based on a partition structure of the neural network and a loop structure included in the neural network operation.

The processor may be configured to prune the inadequate mapping model based on a partition structure of a neural network according to a utilization rate of the processing elements.

The processor may be configured to prune the inadequate mapping model based on a number of iterations of the loop structure.

Other features and aspects will be apparent from the following detailed description, the drawings, and the claims.

### BRIEF DESCRIPTION OF THE DRAWINGS

FIG. 1 is a diagram illustrating an example of a code generation apparatus.

FIG. 2 illustrates an example of arranging a processing element for a neural network operation.

FIG. 3 illustrates an example of an operation of the code generation apparatus of FIG. 1.

FIG. 4 illustrates an example of information on hardware.

FIG. 5 illustrates an example of an operation performed by the code generation apparatus of FIG. 1.

FIG. 6A illustrates an example of a code for performing the operation of FIG. 5.

FIG. 6B illustrates another example of a code for performing the operation of FIG. 5.

FIG. 7 illustrates an example of an attainable operation performance of the code generation apparatus of FIG. 1.

FIG. 8 illustrates an example of a configuration of an off-chip loop.

FIG. 9 illustrates an example of initialization of a tiling factor for pruning.

FIG. 10 illustrates an example of loop elimination for pruning.

FIG. 11 illustrates an example of a loop interchange for pruning.

FIG. 12 illustrates an example of a code generated by the code generation apparatus of FIG. 1.

FIG. 13 is a diagram illustrating an example of an operation of the code generation apparatus of FIG. 1.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The following structural or functional descriptions of examples disclosed in the present disclosure are merely intended for the purpose of describing the examples and the examples may be implemented in various forms. The examples are not meant to be limited, but it is intended that various modifications, equivalents, and alternatives are also covered within the scope of the claims.

Although terms such as first, second, A, B, (a), (b) may be used herein to describe various members, components, regions, layers, or sections, these members, components, regions, layers, or sections are not to be limited by these terms. These terms should be used only to distinguish one member, component, region, layer, or section from another member, component, region, layer, or section. Thus, a first member, component, region, layer, or section referred to in examples described herein may also be referred to as a second member, component, region, layer, or section without departing from the teachings of the examples. The sequences, or the orders of the constituent elements are not limited by these terms.

When one constituent element is described as being “connected”, “coupled”, or “attached” to another constituent element, it should be understood that one constituent element can be connected or attached directly to another constituent element, and an intervening constituent element can also be “connected”, “coupled”, or “attached” to the constituent elements.

As used herein, the singular forms “a”, “an”, and “the” are intended to include the plural forms as well, unless the context clearly indicates otherwise. It should be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

The use of the term “may” herein with respect to an example or embodiment (e.g., as to what an example or embodiment may include or implement) means that at least one example or embodiment exists where such a feature is included or implemented, while all examples are not limited thereto.

Hereinafter, examples will be described in detail with reference to the accompanying drawings, and like reference numerals in the drawings refer to like elements throughout.

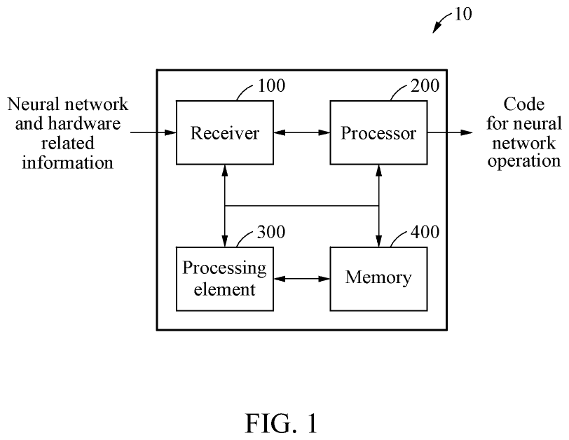

FIG. 1 is a diagram illustrating an example of a code generation apparatus.

Referring to FIG. 1, a code generation apparatus 10 may generate a code for a neural network operation. The code generation apparatus 10 may generate a code for a neural network operation based on information associated with a neural network and information associated with hardware performing the neural network operation. The code generation apparatus 10 may perform the neural network operation based on the generated code.

A code (or a source code) may indicate a text in which a computer program is described in a programming language. The code may be implemented as one or more text files.

A neural network (or an artificial neural network) includes a statistical training algorithm that has an ability to solve a problem, where artificial neurons (nodes) forming the network through synaptic combinations change a connection strength of synapses through training.

In an example, the neural network may include a plurality of layers. The plurality of layers may include an input layer, at least one hidden layer, and an output layer. A layer may include a plurality of nodes. The neural network may map input data and output data that have a nonlinear relationship based on deep learning to perform tasks such as, for example, speech recognition and image recognition.

The neural network may be trained to perform a desired operation by mapping input data and output data that have a nonlinear relationship therebetween through deep learning to perform various tasks. For example, a neural network may be trained through deep learning as a problem-solving process for optimization to find a point where energy is minimized while training the neural network using provided training data. Through deep learning, for example, supervised or unsupervised learning, weighted connections and other parameters corresponding to an architecture or a model of the neural network may be obtained, and the input data and the output data may be mapped to each other based on the obtained weight. In an example training, a parameter of each of the nodes of the neural network may be adjusted while an error of a result output by the output layer may be propagated backward along the neural network.

Various deep neural network structures are being studied. Since a large quantity of data is needed to perform an operation of the neural network, partially use data in a device having a small on-chip memory may be needed.

The neural network may include a deep neural network. The neural network may include neural networks such as, for example, for example, a convolutional neural network (CNN), a recurrent neural network (RNN), perceptron, feed forward (FF), a radial basis network (RBF), deep feed forward (DFF), a long short term memory (LSTM), a gated recurrent unit (GRU), an autoencoder (AE), a variational autoencoder (VAE), a denoising autoencoder (DAE), a sparse autoencoder (SAE), Markov Chain (MC), a Hopfield network (HN), a Boltzmann machine (BM), a restricted Boltzmann machine (RBM), a Depp belief network (DBN), a deep convolutional network (DCN), a deconvolutional network (DN), a deep convolutional inverse graphics network (DCIGN), a generative adversarial network (GAN), a liquid state machine (LSM), an extreme learning machine (ELM), an echo state network (ESN), a deep residual network (DRN), a differentiable neural computer (DNC), a neural turning machine (NTM), a capsule network (CN), a Kohonen network (KN), and an attention network (AN).

The code generation apparatus 10 includes a receiver 100 and a processor 200. The code generation apparatus 10 may further include a processing element 300 and a memory 400.

The receiver 100 may receive information associated with a neural network and information associated with hardware performing the neural network operation. The receiver 100 may include a receiving interface. The receiver 100 may analyze neural network-related information and hardware-related information and transmit the analyzed information to the processor 200.

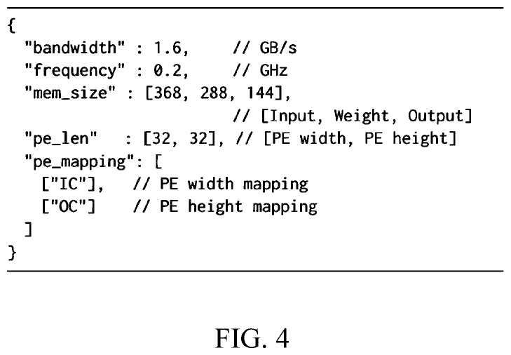

The hardware-related information may include a number of the plurality of processing elements 300, a structure of the processing element 300, a memory bandwidth, a frequency, or a memory size. In other words, the receiver 100 may receive the number of the plurality of processing elements 300, the structure of the processing element 300, the memory bandwidth, the frequency, or the memory size. Such hardware-related information is described in greater detail with reference to FIG. 4.

The processor 200 may process data stored in the memory 400. The processor 200 may execute computer-readable code (e.g., software) stored in the memory 400 and instructions induced by the processor 200.

The processor 200 may be a processing device implemented in hardware having a circuit having a physical structure for executing desired operations. For example, the desired operations may include codes or instructions included in a program. Further description of the processor 200 is given below.

In an example, the processing device implemented in hardware may include a microprocessor, a central processing unit (CPU), single processor, independent processors, parallel processors, single-instruction single-data (SISD) multiprocessing, single-instruction multiple-data (SIMD) multiprocessing, multiple-instruction single-data (MISD) multiprocessing, multiple-instruction multiple-data (MIMD) multiprocessing, a controller and an arithmetic logic unit (ALU), a DSP, a microcomputer, a processor core, a multi-core processor, and a multiprocessor, an application-specific integrated circuit (ASIC), a field programmable gate array (FPGA), a programmable logic unit (PLU), a central processing unit (CPU), a graphics processing unit (GPU), a neural processing unit (NPU), or any other device capable of responding to and executing instructions in a defined manner. The code generating apparatus 10 may be any apparatus that may collect input and generate code to control any processor or such specialized hardware devices.

The processor 200 may generate a target mapping model mapping the neural network operation on the plurality of processing elements 300 performing the neural network operation based on information on hardware and a structure of a neural network.

A mapping model may include a partition structure of the weights or kernels, input data, or output data used for the neural network operation, and a loop structure for performing the neural network operation. The mapping model may include information on a form of assigning the neural network operation to the plurality of processing elements 300.

The processor 200 may calculate or estimate a mapping parameter corresponding to an arbitrary mapping model based on the information on the hardware and the structure of the neural network.

The processor 200 may calculate or estimate an operation performance to be attained by the arbitrary mapping model based on a partition structure of the neural network. The processor 200 may calculate or estimate a utilization rate of the plurality of processing elements based on the partition structure of the neural network. The processor 200 may calculate or estimate the operation performance based on the utilization rate.

The processor 200 may calculate or estimate a memory access size required for the arbitrary mapping model based on a loop structure included in the neural network operation. The processor 200 may calculate or estimate a number of data reload of the arbitrary mapping model based on the loop structure. The processor 200 may calculate or estimate the memory access size based on the number of data reload and the partition structure.

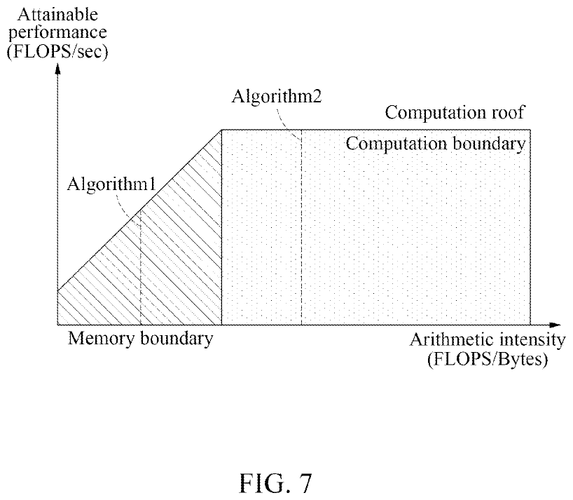

The processor 200 may calculate or estimate the mapping parameter based on the operation performance and the memory access size. A calculation of the mapping parameter is described in greater detail with reference to FIG. 7.

The processor 200 may determine the target mapping model based on the mapping parameter. The processor 200 may determine an arbitrary mapping model that maximizes the mapping parameter to be the target mapping model.

The processor 200 may prune an inadequate mapping model based on a partition structure of the neural network and a loop structure included in the neural network operation.

The processor 200 may prune the inadequate mapping model based on a partition structure of a neural network according to a utilization rate of the plurality of processing elements. The processor 200 may prune the inadequate mapping model based on a number of iterations of the loop structure.

The processor 200 may generate a code for performing the neural network operation based on the target mapping model.

The processing element 300 may perform the neural network operation based on the generated code. The processing element 300 may perform a unit operation included in the neural network operation. In an example, the processing element 300 may include a multiplier accumulator (MAC). In another example, the processing element 300 may be implemented outside the code generation apparatus 10.

The memory 400 may store instructions (or programs) to be executed by the processor. For example, the instructions may include instructions to perform an operation of a processor and/or an operation of each component of the processor.

The memory 400 may be implemented as a volatile memory device or a non-volatile memory device.

The volatile memory device may be implemented as dynamic random-access memory (DRAM), static random-access memory (SRAM), thyristor RAM (T-RAM), zero capacitor RAM (Z-RAM), or twin transistor RAM (TTRAM).

The non-volatile memory may be implemented as electrically erasable programmable read-only memory (EEPROM), a flash memory, magnetic ram (MRAM), spin-transfer torque (STT)-MRAM, conductive bridging RAM (CBRAM), ferroelectric RAM (FeRAM), phase change RAM (PRAM), resistive RAM (RRAM), nanotube RRAM, polymer RAM (PoRAM), nano floating gate memory (NFGM), a holographic memory, molecular electronic memory device, or insulator resistance change memory. Further description of the memory 400 is given below.

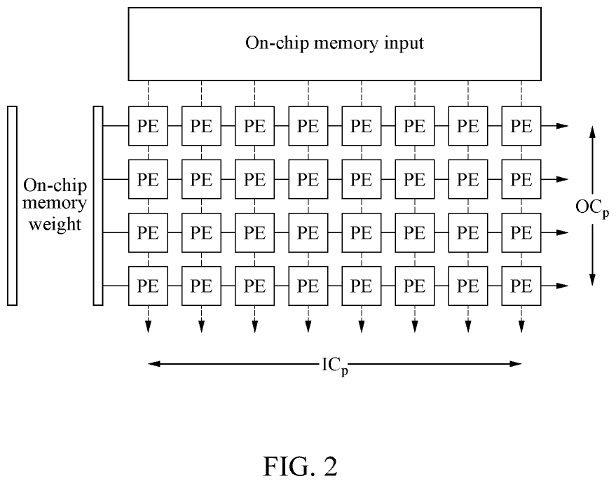

FIG. 2 illustrates an example of arranging a processing element for a neural network operation.

Referring to FIGS. 1 and 2, the processing element 300 may have a multidimensional structure. The processor 200 may determine the memory 400 from which data for performing a neural network operation is to be loaded to the processing element 300. The processor 200 may control the utilization rate of the processing element 300 by adjusting a tiling method of the data for the neural network operation.

The processor 200 may determine a dataflow and a tiling method suitable for each layer included in a neural network and generate a code based on the determined tiling method and dataflow.

The processor 200 may calculate or estimate a maximum operation performance to be attained in hardware when performing the neural network operation based on factors such as, for example, computing power according to a number of cores used for the neural network operation, a quantity of data required for the neural network operation, and a memory bandwidth.

The processor 200 may determine a mapping model based on an attainable operation performance, thereby improving the utilization rate of the processing element 300.

The processor 200 may generate a code based on information on hardware performing the neural network operation. The processor 200 may calculate or estimate a number of processing elements 300 used for the neural network operation in practice based on hardware information including information on a memory bandwidth, a frequency, or a structure of the processing element 300.

In an example, the processor 200 may calculate or estimate computing power based on a total number of cores used for the neural network operation and the calculate or estimated number of processing elements 300.

In an example, the processor 200 may access the memory 400 based on a tiled data quantity and a number of data reload according to the dataflow and calculate or estimate a quantity of data to be loaded.

In an example, the processor 200 may calculate or estimate a maximum value of the operation performance to be attained by the code generation apparatus 10 performing the neural network operation according to the dataflow, and a quantity of data to be tiled based on a quantity of loaded data required when performing the neural network operation and the calculated computing power.

In an example, the processor 200 may calculate or estimate a mapping parameter based on a memory access size and an attainable operation performance and determine a target mapping model based on the calculated mapping parameter.

For example, the processor 200 may calculate a value obtained by dividing the operation performance by the memory access size as a mapping parameter. Also, the processor 200 may determine a tiling method and a dataflow method corresponding to a case in which the mapping parameter is greatest, to be a target mapping model.

Since it is inefficient to compare operation performances for combinations of all tiling methods and all dataflow methods, the processor 200 may prune an inadequate mapping model.

The processor 200 may prune the inadequate mapping model, thereby reducing a search time required to calculate or estimate a mapping parameter of an arbitrary target model for determining the target mapping model.

The processor 200 may prune a combination of a tiling method and a data flow method corresponding to a relatively small mapping parameter value.

The processor 200 may generate a code based on the generated target mapping model. In other words, the processor 200 may generate a code based on a tiling method and a dataflow method included in the target mapping model.

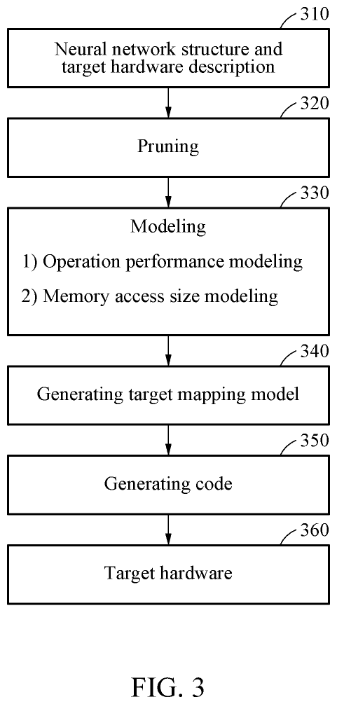

FIG. 3 illustrates an example of an operation of a code generation, such as the code generation apparatus of FIG. 1, and FIG. 4 illustrates an example of information related to the hardware. The operations in FIG. 3 may be performed in the sequence and manner as shown, although the order of some operations may be changed or some of the operations omitted without departing from the spirit and scope of the illustrative examples described. Many of the operations shown in FIG. 3 may be performed in parallel or concurrently. One or more blocks of FIG. 3, and combinations of the blocks, can be implemented by special purpose hardware-based computer, such as a processor, that perform the specified functions, or combinations of special purpose hardware and computer instructions. In an example, the operating method of FIG. 3 may be performed by a processor included in the code generation apparatus 10. In addition to the description of FIG. 3 below, the descriptions of FIGS. 1-2 are also applicable to FIG. 3, and are incorporated herein by reference. Thus, the above description may not be repeated here.

Referring to FIGS. 3 and 4, in operation 310 the receiver 100 may receive information on hardware (or target hardware) and a structure of a neural network. The receiver 100 may receive the information on the hardware in a form of a hardware description file.

The hardware description file may be formed as illustrated in FIG. 4. The hardware description file may include information such as, for example, a number of processing elements 300, a structure of the processing element 300, a memory bandwidth, a frequency, or a memory size.

The structure of the processing element 300 may include information on an arrangement of the processing element 300. For example, the structure of the processing element 300 may include information on a width and a height of a processing element array.

The frequency may be an operating frequency of the processing element 300.

In operation 320, the processor 200 may prune an inadequate mapping model based on a partition structure of the neural network and a loop structure included in the neural network operation.

In operation 330, the processor 200 may calculate or estimate an operation performance to be attained by the arbitrary mapping model based on a partition structure of the neural network and may calculate or estimate a memory access size required for the arbitrary mapping model based on a loop structure included in the neural network operation.

In operation 340, the processor 200 may generate a target mapping model mapping the neural network operation on the plurality of processing elements 300 performing the neural network operation based on the information on the hardware and a structure of a neural network.

In operation 350, the processor 200 may generate a code for performing the neural network operation based on the target mapping model.

In operation 360, the processor 200 may transmit the code for performing the neural network operation to the hardware or target hardware.

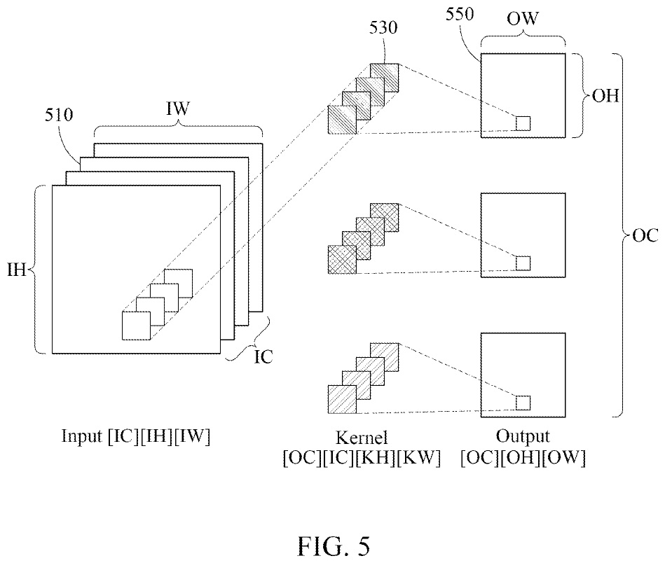

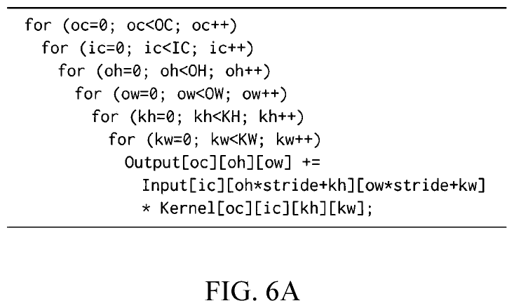

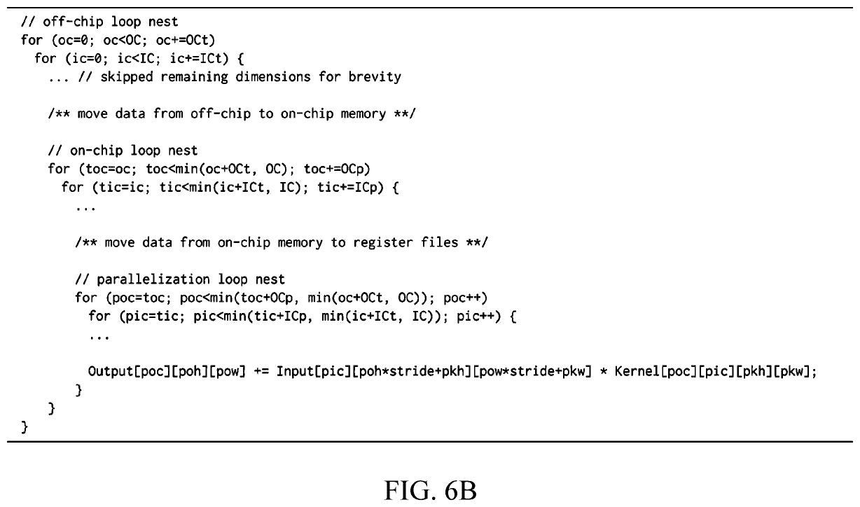

FIG. 5 illustrates an example of an operation performed by a code generation apparatus, such as the code generation apparatuses of FIG. 1, and FIGS. 6A and 6B that illustrate examples of a code for performing the operation of FIG. 5.

Referring to FIGS. 5 through 6B, the code generation apparatus 10 may perform a neural network operation. In an example, the code generation apparatus 10 may perform the neural network operation in real-time. The code generation apparatus 10 may perform a convolution operation.

The convolution operation may refer to an operation of performing a convolution of a feature map and a weight matrix. For example, to perform the convolution operation, a process of generating one component of an output feature map by multiplying and adding corresponding components of the feature map and the weight matrix may be performed repetitively.

Input data for the neural network operation may have a form of a feature map or image. The feature map may be an image processed by a layer included in a neural network.

An input feature map 510 may have a channel, a height, and a width. IW denotes a width of an input feature map, IH denotes a height of the input feature map, and IC denotes a number of channels of the input feature map.

A kernel may refer to a weight matrix for performing a convolution operation with the input feature map 510. The kernel may have a height (e.g., KH) and a width (e.g., KW). Also, the kernel may have a number of channels corresponding to the number of channels IC of the input feature map 510 or a number of channels OC of an output feature map 550. The output feature map 550 may have a channel, a height, and a width. OC denotes the number of channels of the output feature map, OH denotes the height of the output feature map, and OW denotes the width of the output feature map.

FIGS. 6A and 6B illustrate examples of a code for performing the convolution operation of FIG. 5. The convolution operation may be composed of six loop statements as illustrated in FIG. 6A.

The code generation apparatus 10 may change the loop statements of FIG. 6A based on information on hardware performing a neural network operation. A code changed by the code generation apparatus 10 may include an off-chip loop nest for tiling input data and loading the tiled data to the memory 400 (e.g., on-chip memory), an on-chip loop nest for loading the loaded data to a register file to compute the data in the processing element 300, and a parallelization loop nest in which the plurality of processing elements 300 performs operations in parallel.

A loading order may vary based on an order of the off-chip loop nest. In an example, according to the loading order, a dataflow may be divided into an input stationary, a weight stationary, and an output stationary.

The input stationary may refer to a dataflow method in which a loop statement having a channel index of an output feature map is located at an innermost position so that input data is not redundantly loaded.

The weight stationary may refer to a dataflow method in which a loop statement having a width of the output feature map and a height index of the output feature map is located at an innermost position so that weight data is not redundantly loaded.

The output stationary may refer to a dataflow method in which a loop statement having a channel index of an input feature map is located at an innermost position so that output data is not redundantly loaded.

FIG. 7 illustrates an example of an attainable operation performance calculated by the code generation apparatus of FIG. 1.

The processor 200 may calculate or estimate a mapping parameter of an arbitrary mapping model based on information on hardware and a structure of a neural network and determine a target mapping model based on the calculated mapping parameter. The mapping parameter may include an operation performance to be attained by the arbitrary mapping model and a memory access size required for the arbitrary mapping model.

FIG. 7 illustrates an example of an attainable performance according to an arithmetic intensity. The attainable performance may have a unit of floating-point operations per second (FLOPS) per hour. The strength of operation may have a unit of FLOPS per byte. FLOPS may be a number of floating-point operations to be performed by an arbitrary operation device for one second.

The processor 200 may calculate a utilization rate of the plurality of processing elements 300 based on a partition structure of the neural network and calculate an operation performance based on the utilization rate.

For example, the processor 200 may calculate or estimate an attainable operation performance based on a computation roof and the arithmetic intensity. The processor 200 may calculate or estimate the computation roof as shown in Equation 1.

Computation roof=frequency×active PEs [Equation 1]

In Equation 1, frequency is a frequency received by a receiver. The processor 200 may calculate or estimate active processing elements (PEs) as shown in Equation 2. The active PE may be a processing element that is actually used for the neural network operation.

active PEs=Number of PEs×PE [Equation 2]

In an example, the processor 200 may calculate or estimate a processing element utilization rate (e.g., PE utilization) as shown in Equation 3.

$$PE utilization = \frac{Number of operations}{Number of iterations \times Number of PEs} \qquad [ Equation 3 ]$$

In an example, the processor 200 may calculate or estimate a number of operations as shown in Equation 4. Also, the processor 200 may calculate or estimate a number of iterations as shown in Equation 5. In an example, a number of PEs may indicate a value received by the receiver.

$$\begin{matrix}Number of operations = {\prod }_{ }^{ } Tiling factors & [ Equation 4 ] \\ Number of iterations = {\prod }_{ }^{ } ⌈ \frac{Tiling factors}{Unrolling factors} ⌉ & [ Equation 5 ]\end{matrix}$$

A tiling factor and an unrolling factor may be determined based on the mapping model. For example, the processor 200 may reduce a solution space for the tiling factor and the unrolling factor by performing the pruning through tiling factor initialization, loop elimination, and loop interchange. Also, the processor 200 may determine an optimal value from the reduced solution space to be the tiling factor and the unrolling factor.

The processor 200 may calculate or estimate the arithmetic intensity as shown in Equation 6.

$$Arithmetic intensity = \frac{Number of total operations}{DRAM access size} \qquad [ Equation 6 ]$$

In other words, the processor 200 may calculate or estimate the arithmetic intensity by dividing a number of total operations by a DRAM access size.

Finally, the processor 200 may calculate or estimate an attainable operation performance as shown in Equation 7.

$$Attainable Performance = min \{ \begin{matrix}Computation roof \\ Arithmetic intensity \times bandwidth\end{matrix} \qquad [ Equation 7 ]$$

In other words, the processor 200 may calculate or estimate a relatively small value among values obtained from computation roof and arithmetic intensity×bandwidth, to be the attainable operation performance (or attainable maximum operation performance).

Hereinafter, a process of calculating the memory access size by the processor 200 is described in detail.

The processor 200 may calculate or estimate a number of data reload of an arbitrary mapping model based on a loop structure and calculate or estimate a memory access size based on the number of data reload and a partition structure. The memory access size may include a DRAM access size. Hereinafter, a process of calculating the DRAM access size by the processor 200 is described.

Hereinafter, KW, KH, IW, IH, OW, and OH denote a kernel width, a kernel height, an input feature map width, an input feature map height, an output feature map width, and an output feature map height, respectively. Also, subscripts t and p denote a tiling factor and an unrolling factor.

The processor 200 may calculate or estimate the number of data reload according to a dataflow and multiply the number of data reload by a tiled data size, thereby calculating the DRAM access size. For example, the processor 200 may calculate or estimate the DRAM access size as shown in Equation 8.

$$DRAM Access Size = Tiled Data {Size}_{d} \times Number of Data {Reload}_{d} , d = \{ \begin{matrix}input \\ weight \\ output\end{matrix} \qquad [ Equation 8 ]$$

In Equation 8, the variable d represents index of input, weight, or output. For example, Tiled Data Sizeᵢₙₚᵤₜ means tiled data size of input, Tiled Data Size_{weight} means tiled data size of weight, Tiled Data Sizeₒᵤₜₚᵤₜ means tiled data size of output. Here, the processor 200 may calculate or estimate the number of data reload as shown in Equations 9, 10, and 11. The number of data reload may include a number of redundant input data loads, a number of redundant weight loads, or a number of redundant intermediately-generated output data loads.

$$\begin{matrix}Number of Input Reload = ⌈ \frac{KW}{{KW}_{t}} ⌉ \times ⌈ \frac{KH}{{KH}_{t}} ⌉ \times ⌈ \frac{OC}{{OC}_{t}} ⌉ & [ Equation 9 ] \\ Number of Weight Reload = ⌈ \frac{OW}{{OW}_{t}} ⌉ \times ⌈ \frac{OH}{{OH}_{t}} ⌉ & [ Equation 10 ] \\ Number of Psum Reload = ⌈ \frac{KW}{{KW}_{t}} ⌉ \times ⌈ \frac{KH}{{KH}_{t}} ⌉ \times ⌈ \frac{IC}{{IC}_{t}} ⌉ - 1 & [ Equation 11 ]\end{matrix}$$

Equation 9 shows a process of calculating the number of input reload. Equation 10 shows a process of calculating the number of weight reload. Equation 11 shows a process of calculating the number of redundant intermediately-generated output data loads (e.g., number of Psum reload).

In an input stationary dataflow method, the number of input data reload may be 1. In a weight stationary dataflow method, the number of weight reload may be 1. In an output stationary dataflow method, the number of Psum reload may be 1.

The processor 200 may calculate or estimate a value of the mapping parameter using “Performance/DRAM access size.” To take an energy cost and an operation performance into consideration, the processor 200 may determine, to be a target mapping model, a mapping model of which a value obtained by dividing the attainable performance by the memory access size (e.g., the DRAM access size) is the largest.

The processor 200 may repeat a process of calculating the arbitrary mapping model based on the memory access size and the attainable operation performance calculated in the above-described method. The processor 200 may determine, to be the target mapping model, a mapping model having a greatest mapping parameter among mapping parameters calculated repetitively.

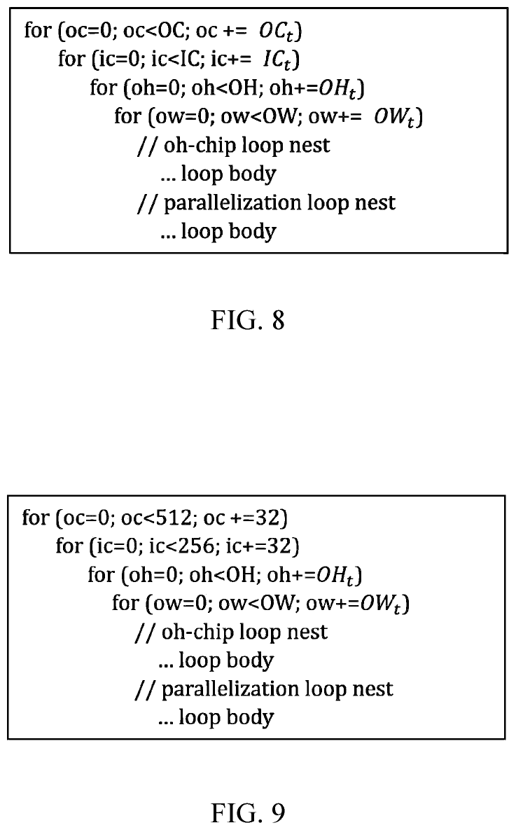

Hereinafter, a process of performing the pruning by the code generation apparatus 10 is described in greater detail with reference to FIGS. 8 through 11.

FIG. 8 illustrates an example of a configuration of an off-chip loop and FIG. 9 illustrates an example of initialization of a tiling factor for pruning.

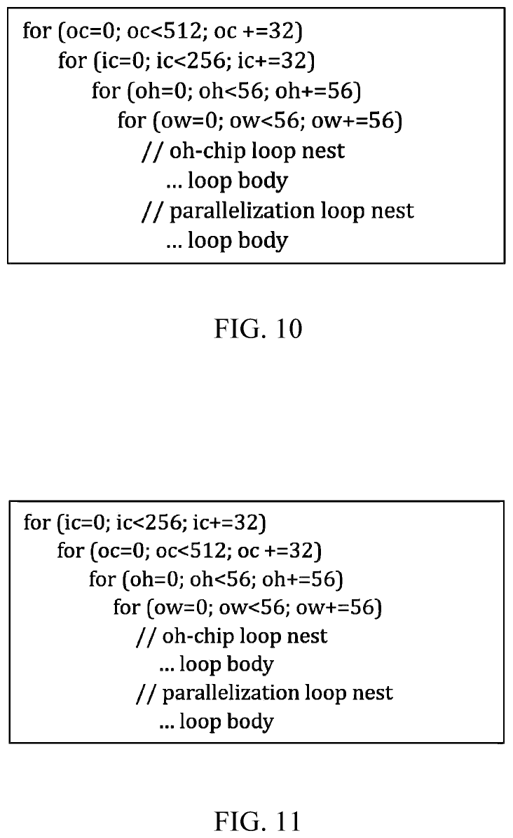

FIG. 10 illustrates an example of loop elimination for pruning and FIG. 11 illustrates an example of a loop interchange for pruning.

Referring to FIGS. 8 through 11, the processor 200 may prune an inadequate mapping model based on a partition structure of a neural network and a loop structure included in a neural network operation.

The processor 200 may prune the inadequate mapping model based on the partition structure of the neural network according to a utilization rate of a plurality of processing elements. In an example, the processor 200 may prune the inadequate mapping model based on a number of iterations of the loop structure.

As described above, a part changed based on a tiling factor and a dataflow when performing a convolution operation may be an off-chip loop nest. FIG. 8 illustrates an example of a configuration of an off-chip loop. In the example of FIG. 8, a loop order and a value of OCₜ, ICₜ, OHₜ, or OWₜ may be changed based on a tiling size and a dataflow method.

The processor 200 may calculate or estimate an attainable operation performance and a memory access size while changing the loop order and the value of OCₜ, ICₜ, OHₜ, or OWₜ. At this time, a number of combinations of loop orders to be considered based on the dataflow may be “4×3×2×1.” Also, a number of combinations of tiling sizes may be “OCₜ×ICₜ×OHₜ×OWₜ.”

For example, in a layer in which a number of channels of an output feature map is 512, a number of channels of an input feature map is 256, a width of the output feature map is 56, and a height of the output feature map is 56, the number of combinations to be considered may be “24×512×256×56×56”, that is, about 10¹⁰.

Since it is inefficient to calculate mapping parameters for all mapping models due to the large number of combinations to be considered, the processor 200 may prune the inadequate mapping model to reduce a number of mapping models for which a mapping parameter is to be calculated.

FIG. 9 illustrates an example of a process of performing the pruning by initializing a tiling factor. The processor 200 may determine a mapping model with a tiling size of which a PE utilization rate is less than or equal to a threshold, to be an inadequate mapping model based on information on hardware. In an example, a value of the threshold is predetermined. Through this, the processor 200 may exclude the inadequate mapping model from a target for consideration.

For example, in a case in which a structure of hardware is as shown in FIG. 4, if Ocₜ and ICₜ, is less than 32 which is a width or height of a processing element array, all the given processing elements 300 may not be utilized. In this example, the processor 200 may calculate or estimate a mapping parameter for only a mapping model having a tiling size greater than or equal to 32, excluding a value corresponding to a tiling size less than 32.

In other words, the processor 200 may determine a mapping model having a tiling structure less than or equal to a threshold to be an inadequate mapping model based on a hardware structure and exclude the determined inadequate mapping model.

As illustrated in FIG. 10, the processor 200 may prune a mapping model for which a mapping parameter is not to be calculated by maximizing or increasing a tiling size.

In the example of FIG. 10, the processor 200 may reduce the number of mapping models to be considered by maximizing the tiling size to reach a size acceptable by the size of the memory 400.

For example, as illustrated in FIG. 10, if a value of OHₜ or OWₜ is set to be the same as a value of OH or OW, the number of iterations of a loop having an index of OH or OW may be 1, so that an effect of eliminating the loop may be achieved.

As such, the processor 200 may set a value of OHₜ for an arbitrary loop to be the same as the height of the output feature map or set a value of OWₜ to be the same as a value of the width of the output feature map. Through this, the processor 200 may exclude the loop from the target for consideration by ensuring that the memory access size and the attainable operation performance are not affected irrespective of a position of the arbitrary loop.

As illustrated in FIG. 11, the processor 200 may prune the inadequate mapping model through a loop exchange. A loop located at an innermost position of a loop statement may not increase the number of data reload and thus, may not affect the memory access size and the attainable operation performance.

Accordingly, by placing a loop having the greatest number of iterations at the innermost position, the processor 200 may reduce the memory access size and reduce the number of mapping models for which mapping parameters are to be calculated.

The example of FIG. 11 may be a case in which OH and OW loops are eliminated through the loop elimination of FIG. 10 and an OC loop having a greater number of iterations among remaining loops, for example, the OC and IC loops is exchanged inwardly.

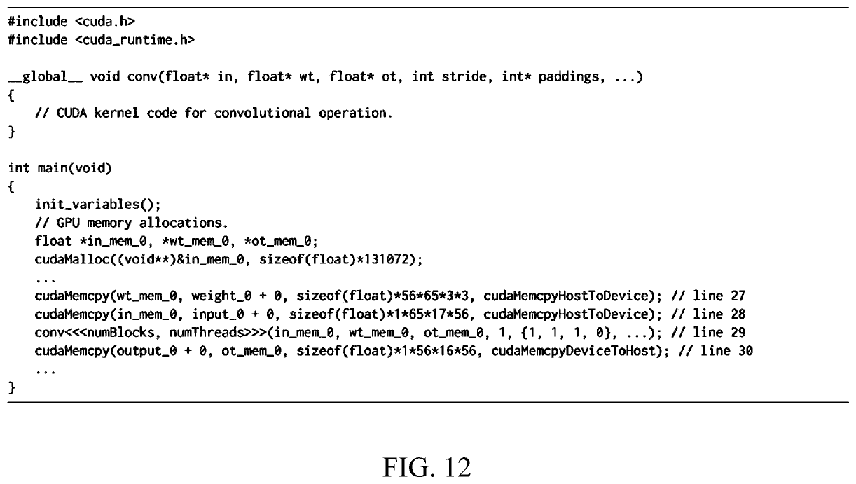

FIG. 12 illustrates an example of a code generated by the code generation apparatus of FIG. 1.

Referring to FIG. 12, the processor 200 may generate a code for performing a neural network operation based on a generated target mapping model.

The processor 200 may generate a code optimized for specific hardware based on a tiling size and a dataflow included in a target mapping model determined to perform an operation like the operation of FIG. 5.

When hardware to perform a neural network operation is a customized accelerator, the processor 200 may generate a code C to reference a dataflow and a tiling size. When hardware to perform a neural network is a graphics processing unit (GPU), the processor 200 may generate a compute unified device architecture (CUDA) code.

The processor 200 may automatically generate a code optimized to hardware based on a neural network structure and information on hardware to perform the neural network operation.

A user may input a neural network that is to perform an operation, to the code generation apparatus 100 in a form of a framework and input a hardware description file into a given format by simply changing a value, thereby generating a code optimized to the hardware.

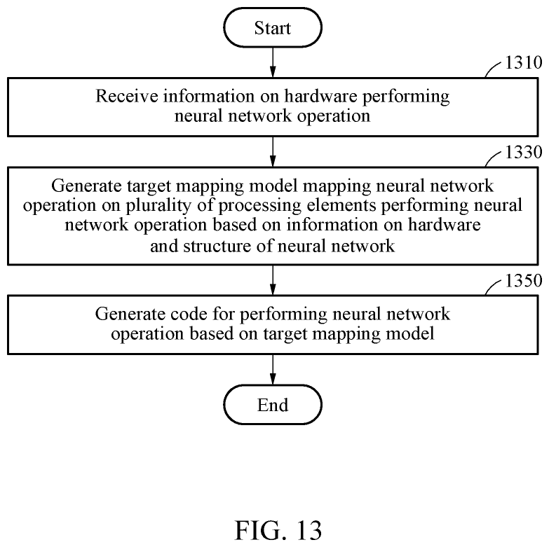

FIG. 13 is a diagram illustrating an example of an automated operation of the code generation apparatus of FIG. 1. The operations in FIG. 13 may be performed in the sequence and manner as shown, although the order of some operations may be changed or some of the operations omitted without departing from the spirit and scope of the illustrative examples described. Many of the operations shown in FIG. 13 may be performed in parallel or concurrently. One or more blocks of FIG. 13, and combinations of the blocks, can be implemented by special purpose hardware-based computer, such as a processor, that perform the specified functions, or combinations of special purpose hardware and computer instructions. In an example, the operating method of FIG. 13 may be performed by a processor included in the code generation apparatus 10 of FIG. 1. In addition to the description of FIG. 13 below, the descriptions of FIGS. 1-12 are also applicable to FIG. 13, and are incorporated herein by reference. Thus, the above description may not be repeated here.

Referring to FIG. 13, in operation 1310, the receiver 100 may receive information on hardware performing a neural network operation. The receiver 100 may receive a number of the plurality of processing elements, a structure of the processing elements, a memory bandwidth, a frequency, or a memory size.

In operation 1330, the processor 200 may generate a target mapping model mapping the neural network operation on the plurality of processing elements 300 performing the neural network operation based on the information on the hardware and a structure of a neural network.

The processor 200 may calculate or estimate a mapping parameter corresponding to an arbitrary mapping model based on the information on the hardware and the structure of the neural network.

The processor 200 may calculate or estimate an operation performance to be attained by the arbitrary mapping model based on a partition structure of the neural network. The processor 200 may calculate or estimate a utilization rate of the plurality of processing elements 300 based on the partition structure of the neural network and calculate or estimate the operation performance based on the utilization rate.

The processor 200 may calculate or estimate a memory access size required for the arbitrary mapping model based on a loop structure included in the neural network operation. The processor 200 may calculate or estimate a number of data reload of the arbitrary mapping model based on the loop structure and calculate or estimate the memory access size based on the number of data reload and the partition structure.

In an example, the processor 200 may calculate or estimate the mapping parameter based on the operation performance to be attained and the memory access size.

In an example, the processor 200 may determine the target mapping model based on the mapping parameter. The processor 200 may determine an arbitrary mapping model that maximizes the mapping parameter to be the target mapping model.

In an example, the processor 200 may prune an inadequate mapping model based on a partition structure of the neural network and a loop structure included in the neural network operation.

In an example, the processor 200 may prune the inadequate mapping model based on a partition structure of a neural network according to a utilization rate of the plurality of processing elements. The processor 200 may prune the inadequate mapping model based on a number of iterations of the loop structure.

In operation 1350, the processor 200 may generate a code for performing the neural network operation based on the target mapping model.

The code generation apparatus 10 and other apparatuses and methods described above disclose a target mapping model based on information on the hardware performing the neural network operation to generate a code for performing a neural network operation based on a mapping model. Thus, improving a utilization rate of the processing elements performing the neural network operation.

The code generation apparatus 10, receiver 100, processor 200, processing element 300, and other apparatuses, units, modules, devices, and other components described herein are implemented by hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, multiple-instruction multiple-data (MIMD) multiprocessing, a controller and an arithmetic logic unit (ALU), a DSP, a microcomputer, an application-specific integrated circuit (ASIC), a field programmable gate array (FPGA), a programmable logic unit (PLU), a central processing unit (CPU), a graphics processing unit (GPU), a neural processing unit (NPU), or any other device capable of responding to and executing instructions in a defined manner.

The methods that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above. In one example, the instructions or software include machine code that is directly executed by the processor or computer, such as machine code produced by a compiler. In an example, the instructions or software includes at least one of an applet, a dynamic link library (DLL), middleware, firmware, a device driver, an application program storing the method of generating a code. In another example, the instructions or software include higher-level code that is executed by the processor or computer using an interpreter. Programmers of ordinary skill in the art can readily write the instructions or software based on the block diagrams and the flow charts illustrated in the drawings and the corresponding descriptions in the specification, which disclose algorithms for performing the operations performed by the hardware components and the methods as described above.

The instructions or software to control a processor or computer to implement the hardware components and perform the methods as described above, and any associated data, data files, and data structures, are recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), magnetic RAM (MRAM), spin-transfer torque (STT)-MRAM, static random-access memory (SRAM), thyristor RAM (T-RAM), zero capacitor RAM (Z-RAM), twin transistor RAM (TTRAM), conductive bridging RAM (CBRAM), ferroelectric RAM (FeRAM), phase change RAM (PRAM), resistive RAM (RRAM), nanotube RRAM, polymer RAM (PoRAM), nano floating gate Memory (NFGM), holographic memory, molecular electronic memory device), insulator resistance change memory, dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and providing the instructions or software and any associated data, data files, and data structures to a processor or computer so that the processor or computer can execute the instructions.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A processor-implemented method of generating a code, the method comprising:
receiving information on hardware configured to perform a neural network operation of a neural network;
generating, using a processor, a target mapping model mapping the neural network operation on processing elements available to perform the neural network operation based on the information and a structure of the neural network; and
generating a code to configure the hardware to perform the neural network operation based on the target mapping model.

2. The method of claim 1, wherein the receiving of the information comprises:
receiving any one or any combination of a number of the processing elements, a structure of the processing element, a memory bandwidth, a frequency, and a memory size.

3. The method of claim 1, wherein the generating of the target mapping model comprises:
calculating a mapping parameter corresponding to an arbitrary mapping model based on the information and the structure; and
determining the target mapping model based on the mapping parameter.

4. The method of claim 3, wherein the calculating of the mapping parameter comprises:
determining an operation performance for the arbitrary mapping model based on a partition structure of the neural network;
calculating a memory access size for the arbitrary mapping model based on a loop structure included in the neural network operation; and
calculating the mapping parameter based on the operation performance and the memory access size.

5. The method of claim 4, wherein the calculating of the operation performance comprises:
calculating a utilization rate of the processing elements based on the partition structure of the neural network; and
calculating the operation performance based on the utilization rate.

6. The method of claim 4, wherein the calculating of the memory access size comprises:
calculating a number of data reload of the arbitrary mapping model based on the loop structure; and
calculating the memory access size based on the number of data reload and the partition structure.

7. The method of claim 3, wherein the determining of the target mapping model based on the mapping parameter comprises:
determining an arbitrary mapping model that maximizes the mapping parameter to be the target mapping model.

8. The method of claim 3, wherein the generating of the target mapping model further comprises:
pruning an inadequate mapping model based on a partition structure of the neural network and a loop structure included in the neural network operation.

9. The method of claim 8, wherein the pruning of the inadequate mapping model comprises:
pruning the inadequate mapping model based on a partition structure of a neural network according to a utilization rate of the processing elements.

10. The method of claim 8, wherein the pruning of the inadequate mapping model comprises:
pruning the inadequate mapping model based on a number of iterations of the loop structure.

11. An apparatus for generating a code, the apparatus comprising:
a receiver configured to receive information on hardware configured to perform a neural network operation of a neural network; and
a processor configured to generate a target mapping model mapping the neural network operation on processing elements available to perform the neural network operation based on the information and a structure of the neural network and to generate a code to configure the hardware to perform the neural network operation based on the target mapping model.

12. The apparatus of claim 11, wherein the receiver is further configured to receive any one or any combination of a number of the processing elements, a structure of the processing element, a memory bandwidth, a frequency, and a memory size.

13. The apparatus of claim 11, wherein the processor is further configured to:
calculate a mapping parameter corresponding to an arbitrary mapping model based on the information and the structure; and
determine the target mapping model based on the mapping parameter.

14. The apparatus of claim 13, wherein the processor is further configured to:
calculate an operation performance to be attained by the arbitrary mapping model based on a partition structure of the neural network;
calculate a memory access size for the arbitrary mapping model based on a loop structure included in the neural network operation; and
calculate the mapping parameter based on the operation performance and the memory access size.

15. The apparatus of claim 14, wherein the processor is further configured to:
calculate a utilization rate of the processing elements based on the partition structure of the neural network; and
calculate the operation performance based on the utilization rate.

16. The apparatus of claim 14, wherein the processor is further configured to:
calculate a number of data reload of the arbitrary mapping model based on the loop structure; and
calculate the memory access size based on the number of data reload and the partition structure.

17. The apparatus of claim 13, wherein the processor is further configured to:
determine an arbitrary mapping model that maximizes the mapping parameter to be the target mapping model.

18. The apparatus of claim 13, wherein the processor is further configured to:
prune an inadequate mapping model based on a partition structure of the neural network and a loop structure included in the neural network operation.

19. The apparatus of claim 18, wherein the processor is further configured to:
prune the inadequate mapping model based on a partition structure of a neural network according to a utilization rate of the processing elements.

20. The apparatus of claim 18, wherein the processor is further configured to:
prune the inadequate mapping model based on a number of iterations of the loop structure.
